(19) United States
(12) Patent Application Publication
(10) Pub. No.: US 2021/0217005 A1
(43) Pub. Date: Jul. 15, 2021

(54) TOKENIZATION OF CONTACTLESS CARDS

(71) Applicant: Mastercard International Incorporated, Purchase, NY (US)

(72) Inventors: Shawn J. Mehrhoff, Saint Ann, MO (US); Christopher T. Scholl, Florissant, MO (US)

(73) Assignee: Mastercard International Incorporated, New York, NY (US)

(21) Appl. No.: 16/740,803

(22) Filed: Jan. 13, 2020

(51) Int. Cl. G06Q 20/38; G06Q 20/34; G06Q 20/36; G06Q 20/40

(52) U.S. Cl. CPC G06Q 20/3825; G06Q 20/352; G06Q 2220/00; G06Q 20/4014; G06Q 20/409; G06Q 20/367

(57) ABSTRACT

The disclosure describes systems and methods for tokenizing a contactless payment card. A token requesting device receives contactless card data associated with the contactless payment card and transmits a token request message to a token service system. The token service system generates a contactless token for the contactless payment card. The contactless token is associated with the contactless card data, for example, in a token vault. The token requesting device establishes a wireless communication connection with the contactless payment card. The contactless token is then written to a token data portion of the contactless payment card memory device and a pointer stored in the token data portion of the contactless payment card memory device is updated to point to the contactless token.

### FIELD OF THE DISCLOSURE

The field of the disclosure relates generally to contactless payment cards used for the payment of goods and/or services and, more particularly, to securing data stored on a contactless payment card through the use of tokens.

### BACKGROUND OF THE DISCLOSURE

Various payment systems utilize contactless integrated circuit (IC) cards (e.g., contactless EMV cards, contactless chip cards, and the like) which may communicate with a point-of-sale (POS) terminal via wireless communication. During a purchase transaction, the payment card account number and other information is transmitted from the contactless payment card to the payment terminal, for example, via NFC wireless communication. Authorization and clearing may then proceed in substantially the same manner as for a transaction initiated with a conventional credit card or debit card having a magnetic stripe.

Payment tokens are surrogate values that may be used to replace a primary account number (PAN) of a payment card in the payment system. Such tokens provide increased protection against fraudulent use such as counterfeiting, account misuse, and other forms of fraud. However, despite various payment use cases involving the transfer of payment tokens instead of PANs, typical contactless payment cards still have the PAN stored within the electronic chip and within the magnetic stripe. As a result, a fraudster can eavesdrop on a contactless payment transaction and capture the card data that is transmitted wirelessly during the transaction.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computer-implemented method for tokenizing a contactless payment card is provided. The contactless payment card includes a memory device. The method includes receiving, by a token requesting device, contactless card data associated with the contactless payment card and transmitting, by the token requesting device, a token request message to a token service system. The method also includes generating, by the token service system, a contactless token for the contactless payment card. The contactless token is associated with the contactless card data. Furthermore, the method includes establishing, by the token requesting device, a wireless communication connection with the contactless payment card and writing, by the token requesting device, the contactless token to a token data portion of the contactless payment card memory device. Moreover, the method includes updating, by the token requesting device, a pointer stored in the token data portion of the contactless payment card memory device to point to the contactless token.

In another aspect, a token service system is provided. The token service system includes a contactless payment card having a card memory device including an EMV data portion and a token data portion. The EMV data portion has stored thereon payment account information associated with an authorized cardholder of the contactless payment card. The token data portion has stored thereon a pointer initially pointing to the payment account information. The system also includes a token service system having a first processor programmed to generate a contactless token for the contactless payment card. The contactless token is associated with the payment account information. Furthermore, the system includes a token requesting device having a second processor communicatively coupled to a token requesting device memory device. The second processor is programmed to receive the payment account information stored on the card memory device. The processor is also programmed to transmit a token request message to a token service system. Moreover, the processor is programmed to establish a wireless communication connection with the contactless payment card and write to the token data portion of the card memory device the contactless token. Furthermore, the processor is programmed to update the pointer stored in the token data portion of the card memory device to point to the contactless token.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an example multi-party payment card network system, in accordance with one embodiment of the present disclosure;

FIG. 2 is a simplified block diagram of an example payment card network system, such as the payment card network system shown in FIG. 1, including a plurality of computing devices and the token service system;

FIG. 3 is a schematic front view of a contactless card for use in the payment card network system shown in FIG. 1;

FIG. 4A is a simplified block diagram of a memory device of the contactless card shown in FIG. 3, representing a memory state before tokenization of the contactless card;

FIG. 4B is a simplified block diagram of the memory device shown in FIG. 4A, representing a state after a contactless token has been written to the contactless card;

FIG. 5 is an example configuration of a user system for use in the payment card network system shown in FIG. 1;

FIG. 6 is an example configuration of a server system for use in the payment card network system shown in FIG. 1; and

FIGS. 7A and 7B cooperatively depict flowchart illustrating an exemplary computer-implemented method for tokenizing a contactless payment card, such as the contactless card shown in FIG. 3, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. It is contemplated that the invention has general application for generating and writing token data to a contactless payment card. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

Embodiments of the present technology relate to systems, methods, and computer-readable media for generating a token for a contactless payment card. As such, the consumer is able to perform contactless payment transactions with his or her contactless payment card without worrying about having the actual payment account data transmitted between the card and the merchant, and the merchant and the payment network.

As will be appreciated, based upon the description herein, the technical improvement in tokenizing the contactless payment transaction of a contactless payment card, as described is a technical solution to a technical deficiency or problem that is itself rooted in computer technology (i.e., the problem itself derives from the use of computer technology). More specifically, the technical problems with EMV chip cards that are enabled for contactless transactions are the result of an implementation and use of computers in financial institution processing systems and methods intended to keep the financial account data private and secured. The present disclosure improves upon the conventional methods and systems in the manners described herein. Thus, the inefficiencies or technical problems created by conventional financial institution data processing systems and methods are solved by the methods and systems described and particularly claimed.

### Payment Network Systems

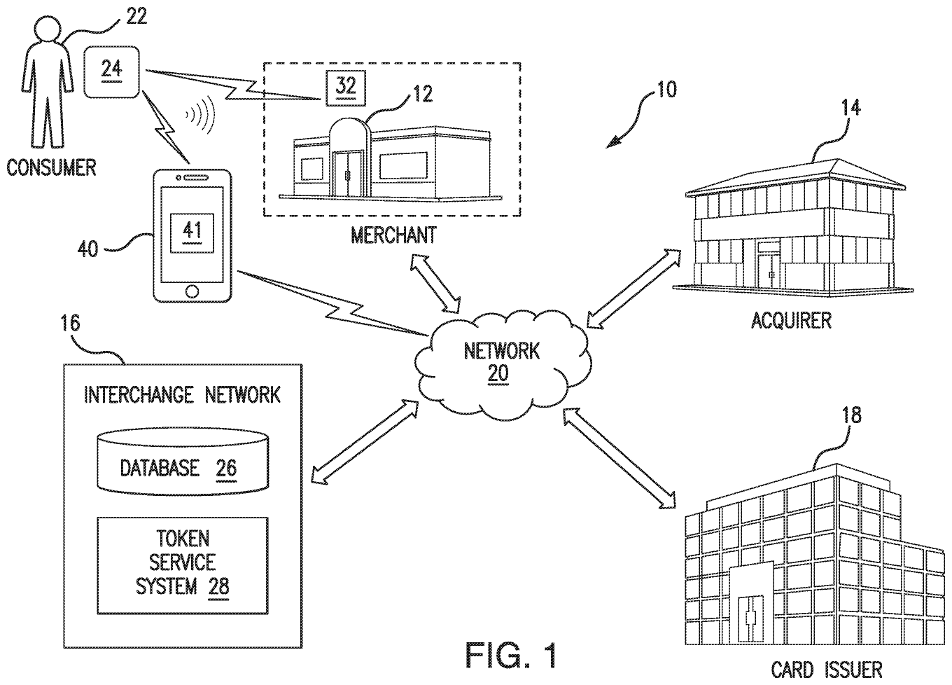

FIG. 1 is a block diagram of an example multi-party payment card network system 10. The payment card network system 10 facilitates providing interchange network services offered by an interchange network 16. In addition, the payment card network system 10 enables contactless payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc. As used herein, the term “interchange network” includes an electronic network that exchanges data relating to the value of card sales and credits among the issuers 18 and the acquirers 14 (e.g., networks maintained, for example, by Mastercard®). (Mastercard is a registered trademark of Mastercard International Incorporated.)

In the example embodiment, the payment card network system 10 generally includes the merchants 12, the acquirers 14, the interchange network 16, and the issuers 18 coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and/or the issuers 18, and, separately, the public Internet, which may facilitate communication between the merchants 12, the interchange network 16, the acquirers 14, and consumers 22, etc.

Embodiments described herein may relate to a transaction card system, such as a credit card payment system using the Mastercard interchange network. The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by an issuer, purchase data representing a purchase made by the consumer, including a type of merchant, amount of purchase, date of purchase, and other data, which may be transmitted between any parties of multi-party payment card network system 10.

In a transaction card system as described herein, a financial institution called the “issuer” issues a contactless payment card, such as a contactless card 24, to a cardholder or consumer 22, who uses the contactless card 24 to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

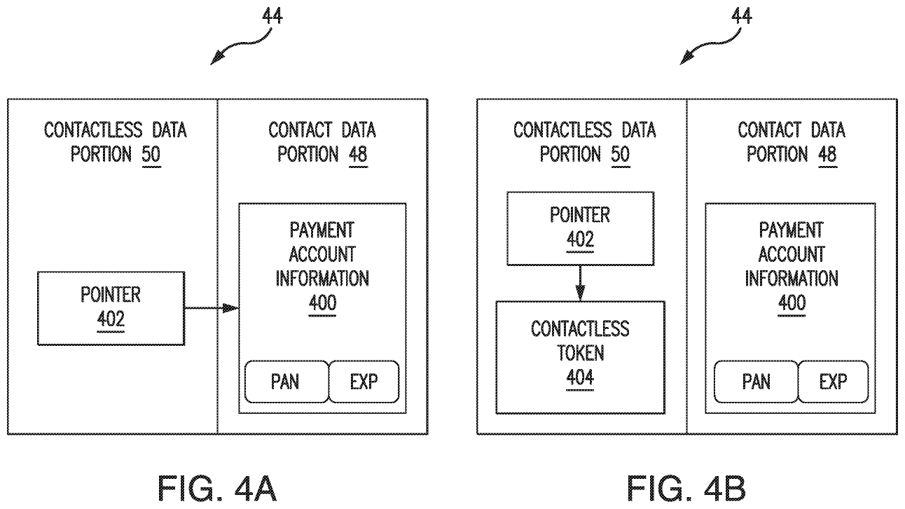

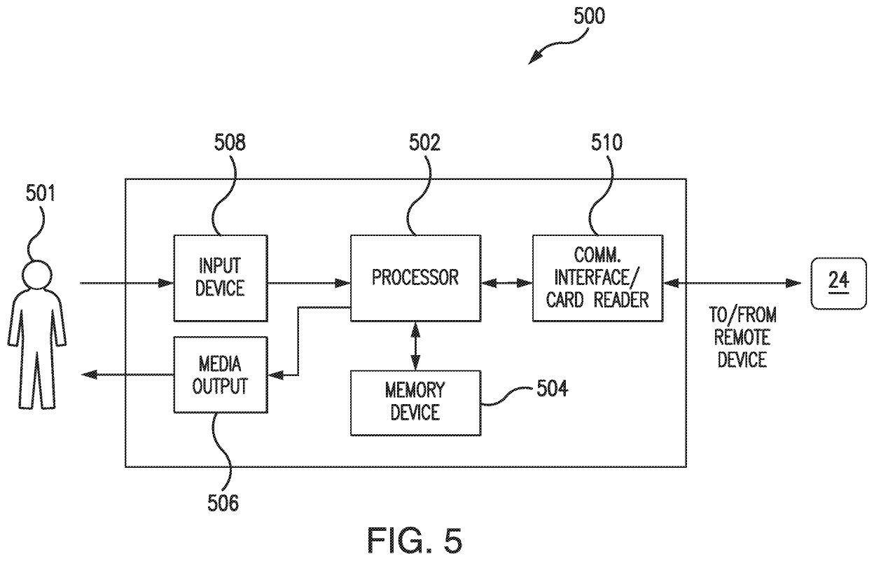

To accept payment with the contactless card 24, the merchant 12 must normally establish an account with a financial institution that is part of the payment card network system 10. This financial institution is usually called the “merchant bank,” the “acquiring bank,” or the acquirer 14. When the consumer 22 provides payment for a purchase with the contactless card 24, the merchant 12 requests authorization from the acquirer 14 for the purchase amount. The request may be performed over the telephone but is usually performed using a point-of-sale (POS) terminal, such as the POS terminal 32, that wirelessly connects to the contactless card 24 and reads the consumer's payment account information 400, such as a primary account number (PAN), (shown in FIGS. 4A and 4B) from an integrated circuit chip on the contactless card 24 and communicates electronically with the transaction processing computers of the acquirer 14. Alternatively, the acquirer 14 may authorize a third party to perform transaction processing on its behalf. In this case, the POS terminal 32 will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the consumer's account is in good standing and whether the purchase is covered by the consumer's available credit line. Based on these determinations, the request for authorization will be declined or accepted. If the request is accepted, an authorization code is issued to the merchant 12.

When a request for authorization is accepted, the available credit line of the consumer's account is decreased. Normally, a charge for a payment card transaction is not posted immediately to the consumer's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the POS terminal 32. This may include bundling of approved transactions daily for standard retail purchases. If the consumer 22 cancels a transaction before it is captured, a “void” is generated. If the consumer 22 returns goods after the transaction has been captured, a “credit” is generated. The interchange network 16 and/or the issuer 18 stores the transaction data, such as, and without limitation, the PAN, a type of merchant, a merchant identifier, a location where the transaction was completed, an amount of purchase, a merchant category code, a date and time of the transaction, products purchased and related descriptions or identifiers, etc., in a transaction database 26.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, consumer account information, a type of transaction, itinerary information, information regarding the purchased item and/or service, and/or other suitable information, is associated with a transaction and transmitted between the parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data and stored within the transaction database 26, at the merchant 12, the acquirer 14, the payment network 16, and/or the issuer 18. Further, transaction data, unrelated to a particular payment account, may be collected by a variety of techniques, and similarly stored within the transaction database 26.

In some embodiments, consumers 22 involved in the transactions described herein are prompted to agree to legal terms associated with their payment accounts, for example, during enrollment in such payment accounts, etc. As such, the consumer 22 may voluntarily agree to allow the merchants 12, the issuers 18, the interchange network 16, etc., to utilize data collected during enrollment and/or collected relating to processing the transactions, subsequently for one or more of the purposes described herein.

As described above, the consumer's PAN is passed from the contactless card 24 to the POS terminal 32, typically without the requirement of entering a PIN. In many instances, the PAN and the associated expiry date may be saved to various databases, such as the database 26. Contactless card transactions can be performed in one of two modes: EMV mode and mag-stripe mode. Contactless mag-stripe mode is provided to support older infrastructure that cannot handle EMV data and typically involves the passing of the card data wirelessly as track 1 and/or track 2 data. Contactless EMV mode is more secure than mag-stripe mode and includes a unique cryptogram for the specific transaction.

In contactless EMV mode, security may be compromised as such transactions typically involve only one cryptogram, and not two, as is common in contact transactions. The PAN and expiry date are not encrypted. Rather, the cleartext, static PAN is still included in the transaction message, in addition to the cryptogram. Fraudsters can eavesdrop on the wireless communication to capture the card data (e.g., the track 1 and/or track 2 data, or the cryptogram transaction). It is known that passive eavesdropping can be successfully performed at a distance up to eighteen meters (18 m) away from the transaction devices.

Transactions initiated by the contactless card 24 at the POS terminal 32 do not include tokenized account data (such data including, for example, the PAN and the expiry date). Rather, the actual PAN and expiry date are read by the POS terminal 32 from the contactless card 24. As a result, it is possible that merchant data breaches, compromised transactions (e.g., via eavesdropping), and the like can cause the actual PAN and expiry date of a payment card to be exposed to fraudsters. An intercepted and/or stolen PAN and associated expiry date can be used by fraudsters to perform fraudulent transactions using the compromised card data, such as in mag-swipe transactions, online or electronic commerce, card-on-file transactions, mail order/telephone order (MOTO) channels, and the like. Providing contactless payment tokens for contactless or wireless transactions being performed by contactless-enabled payment cards, such as the contactless card 24, can reduce the chance of fraud by eliminating the ability of fraudsters to gain access to the actual PANs and expiry dates of payment cards.

Thus, referring back to FIG. 1, the interchange network 16 includes the token service system 28, which is configured to generate or assign one or more contactless payment tokens to respective payment accounts that are to be tokenized. Tokenization can be performed, for example, at the POS terminal 32, at a consumer computing device 40, a contactless ATM, and the like. The consumer computing device 40, for example, may include a digital wallet or banking application 41 executing thereon to facilitate tokenizing or updating a contactless token on the contactless card 24.

In one embodiment, during a tokenization operation, for example, being performed at a POS terminal 32, the PAN is sent to the card issuer 18 along with a request message to tokenize the PAN. In some embodiments, the card issuer 18 may evaluate risk associated with the token request message and perform other assessments and/or processing before approving and transmitting the token request message to the token service system 28. The token service system 28 generates or assigns a contactless payment token (e.g., the contactless token 404 (shown in FIG. 4B)) to the PAN (e.g., the payment account) to be tokenized and creates an association mapping between the contactless token 404 and the PAN. The token service 28 stores the contactless token-to-PAN mapping data (e.g., in a data mapping table) in a database, such as the database 26. The token service system 28 transmits the contactless token 404, for example, to the POS terminal 32 such that the contactless token 404 can be written to and stored on the contactless card 24. This process is generally the same whether being performed at a POS terminal 32, the consumer computing device 40, a contactless ATM, or any other suitable NFC enabled device.

In some embodiments, the token service system 28 communicates directly with the card issuer 18, for example, via an API. Such embodiments include instances where the card issuer 18 is responsible for card production and provides the contactless card 24 to the consumer 22 such that the contactless card 24 is provided with tokenized data already stored thereon. As such, contactless card tokenization can be performed not only for initial card issuance but also for consumer initiated tokenization and or replacement tokenization (e.g., in instances where a token has been compromised).

While only one merchant 12, acquirer 14, interchange network 16, and issuer 18 are shown in FIG. 1 (for ease of reference), it should be appreciated that a variety of other embodiments may include multiple ones of these parties in various combinations.

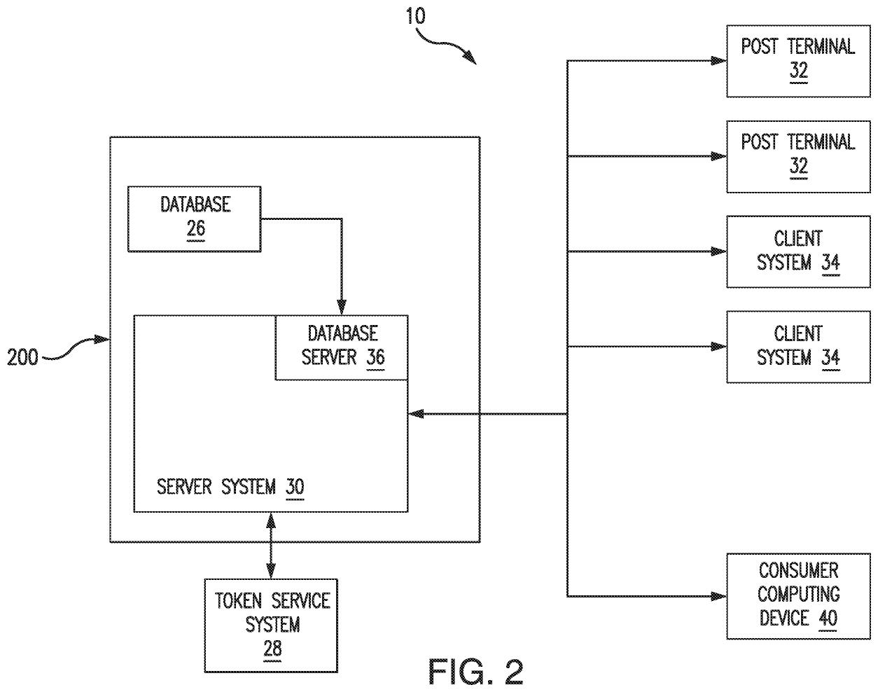

FIG. 2 is a simplified block diagram of an example payment card network system, such as the payment card network system 10 (shown in FIG. 1), including a plurality of computing devices and the token service system 28. In the example embodiment, the plurality of computing devices include, for example, a processing system 200 having a server system 30, POS terminals 32 located at merchants, such as the merchant 12 (shown in FIG. 1), client systems 34 (e.g., contactless ATMs, computers, etc.) associated with merchants, merchant banks, payment networks, and/or issuer banks (e.g., the issuer 18 (shown in FIG. 1)), and the computing device 40 associated with the consumer 22 (shown in FIG. 1). In one embodiment, the payment card network system 10 implements a process for processing contactless card tokenization request data using the token service system 28.

More specifically, the token service system 28 is in communication with the server system 30 and may be a component of the server system 30 or a separate computing device. The token service system 28 is configured to receive tokenization requests and contactless card data related to a contactless card, such as the contactless card 24. The contactless card data includes identifying information of the contactless card 24, such as such as an account number (e.g., the PAN), an expiry date, a Card Security Code (CSC), and the like. The contactless card data is stored in a memory device and/or database, such as the database 26. In one embodiment, the contactless card data is received from one or more sources including, for example, a POS terminal 32, a client system 34, a consumer computing device 40, and the like.

The CSC discussed above, which may be referred to as a Card Verification Value (CVV or CVV2), Card Verification Value Code (CVVC), Card Verification Code (CVC), Verification Code (V-Code or V Code), or Card Code Verification (CCV) value, is a security feature used in payment card transactions for providing increased protection against payment card fraud. Several types of CSC's have been implemented for payment cards. For example, a first type of CSC, for example, a CVC1 or CVV1, is encoded on the magnetic stripe of a payment card and is used in card present transactions. A second type of CSC, for example, a CVC2, CVV2, or card identification number “CID,” is typically requested by a merchant in a CNP transaction. For ease of understanding, the base CVC designation will be used herein when referring to a card security code.

A CVC2 value is a three (3) or four (4) digit number that is printed on a payment card, often on the signature strip, but which is not encoded on the magnetic stripe. Mastercard® branded payment cards, for example, typically include a three (3) digit code. The CVC2 is typically not embossed like a primary account number (PAN) and is typically the final group of numbers printed on the back signature panel of the card. In some applications, the CVC2 appears in a separate panel located to the right of the signature strip. A CVC2 value is typically generated when the payment card is issued by concatenating the PAN, the payment card expiry date, and a service code and hashing under a cryptographic key or keys known only to the issuing bank. Based upon these three (3) inputs and the additional cryptographic keys, the algorithm calculates a resultant ciphertext wherein a portion of the ciphertext is used as the CVC2 value that is printed on the payment card.

In the exemplary embodiment, as described above, the processing system 200 includes the server system 30 of, for example, the interchange network 16 (shown in FIG. 1), coupled in communication with the POS terminals 32, the client systems 34 (also includes client sub-systems), and the consumer computing device 40. In one embodiment, the client systems 34 and the consumer computing device 40 are computers that include a web browser, such that the server system 30 is accessible to the client systems 34 and the consumer computing device 40 using the Internet. The client systems 34 and the consumer computing device 40 are interconnected to the Internet through any one or more of many interfaces including, for example, a network, such as a LAN or WAN, dial-in-connections, cable modems, and/or special high-speed Integrated Services Digital Network (ISDN) lines. The client systems 34 and consumer computing device 40 could be any device capable of interconnecting to the Internet including an Internet connected phone, a PDA, or any other suitable web-based connectable equipment.

The POS terminals 32 may be connected to the client systems 34 or may be connected to the server system 30. The POS terminals 32 may be interconnected to the Internet (or any other network that allows the POS terminals 32 to communicate as described herein) through any one or more of many possible interfaces including a network, such as a local area network (LAN) or a wide area network (WAN), dial-in-connections, cable modems, wireless modems, and special high-speed ISDN lines. The POS terminals 32 are any device capable of interconnecting to the Internet and including an input device capable of reading information from a consumer's financial payment card. In some embodiments, the POS terminal 32 may be a consumer's personal computer, such as when conducting an online purchase through the Internet. As used herein, the terms POS device, POS terminal, and point of interaction device are used broadly, generally, and interchangeably to refer to any device in which the consumer 22 interacts with to complete a contactless card transaction, such as a tokenization request. Furthermore, in some instances, rather than the consumer 22, it may be a card issuer 18 completing a tokenization request.

A database server 36 is connected to the database 26, which is configured to store information on a variety of matters, including tokenization data corresponding to the contactless card 24, as is described herein in greater detail. In one embodiment, the database 26 is a centralized database stored on the server system 30. The database 26 may be accessed by potential users at one of the client systems 34 by logging onto the server system 30 through one of the client systems 34. In an alternative embodiment, the database 26 is stored remotely from the server system 30 and may be a distributed or non-centralized database.

In one example embodiment, the database 26 may include a single database having separated sections or partitions or may include multiple databases, each being separate from each other. The database 26 may store transaction data generated as part of sales activities conducted over the processing network, including data relating to merchants, account holders or customers, issuers, acquirers, savings amounts, savings account information, and/or purchases made. The database 26 may also store account data including at least one of a consumer name, a consumer address, an account number, and other account identifiers that relate the contactless card 24 to the consumer, such as the consumer 22. The database 26 may also store merchant data including a merchant identifier that identifies each merchant registered to use the network, and instructions for performing and settling transactions, including merchant bank account information. The database 26 may also store authorization request data and tokenization request data.

In the exemplary embodiment, one of the client systems 34 may be associated with the acquirer 14 (shown in FIG. 1) while another one of the client systems 34 may be associated with the issuer 18 (shown in FIG. 1). The POS terminal 32 may be associated with the merchant 12 (shown in FIG. 1) or may be a computer system and/or mobile computing system used by a cardholder (e.g., the consumer 22 (shown in FIG. 1)) making an on-line purchase or payment. The server system 30 may be associated with the interchange network 16 or another payment processor. In the example embodiment, the server system 30 is associated with a financial transaction processing network, such as the interchange network 16, and may be referred to as an interchange computer system. The server system 30 may be used for processing tokenization and transaction data. In addition, the client systems 34 and the POS terminals 32 may include a computer system associated with at least one of a merchant, an online bank, a bill payment outsourcer, an acquirer bank, an acquirer processor, an issuer bank associated with a payment card, an issuer processor, a remote payment processing system, a third-party aggregator, and/or a biller.

In the example embodiment, the processing system 200 is in communication with the token service system 28, which may be associated with the interchange network 16 or with an outside third party in a contractual relationship with the interchange network 16. In the example embodiment, the token service system 28 processes tokenization requests and assigns contactless tokens to contactless payment cards, such as the contactless card 24, and as such, is configured to provide various transaction information to one or more parties involved in the tokenization request, such as the card issuer 18 and the consumer 22. It is noted that the payment network 100 may include more, fewer, or alternative components and/or perform more, fewer, or alternative actions, including those discussed elsewhere herein.

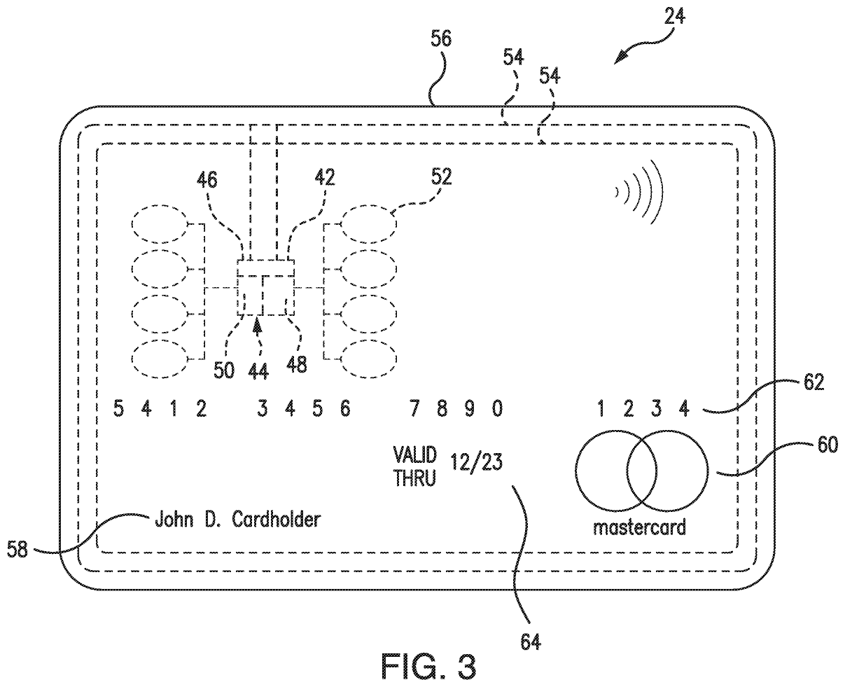

FIG. 3 is a schematic front view of the contactless card 24. In the exemplary embodiment, the contactless card 24 includes an embedded integrated circuit (IC) or micromodule 42 that stores and transmits data between electronic devices. The micromodule 42 includes a silicon integrated circuit chip with a memory device 44 and a processor 46. The memory device includes at least two (2) separate secure portions, including an EMV data portion 48 and a token data portion 50. In the exemplary embodiment, the data stored on the micromodule 42 is associated with one or more payment accounts linked to respective funding sources, such as the consumer deposit account (not shown). The token data portion 50 is operable to store a contactless token 404 (shown in FIG. 4B). As described herein, the data stored on the EMV data portion 48 and/or the token data portion 50 includes payment account information 400 (shown in FIGS. 4A and 4B), such as the PAN and the expiry date of the contactless card 24, and the contactless token 404 associated with the PAN and expiry date of the contactless card 24.

As shown in FIG. 3, the micromodule 42 includes a plurality of electrical contacts 52 for communication between the contactless card 24 and the POS terminal 32 (shown in FIG. 2). In addition, the contactless card 24 includes an antenna 54, which is provided for contactless communication, such as, for example, using near field communication (NFC). For example, in one embodiment, the antenna 54 generates a magnetic field when it vibrates at a selected frequency. Specifically, the antenna 54 is configured to vibrate at a frequency of about 13.56 MHz, which is suitable for use in a near field communication (NFC) system.

In the example embodiment, the antenna 54 transmits radio signals to and receives radio signals from other NFC-enabled computing devices, for example, the merchant POS terminal 32, and/or any other components used in NFC systems. In NFC systems, at least one NFC component generates a magnetic field to inductively transfer currents and, thereby, exchange signals and information with other NFC components positioned within the magnetic field. In the exemplary embodiment, the antenna 54 functions as an NFC component to send and receive signals. The antenna 54 is configured to transmit radio signals to NFC components positioned within the magnetic field of the antenna 54, such as when the POS terminal 32 or the consumer computing device 40, is located within a predetermined distance of the contactless card 24. As such, the antenna 54 sends and receives radio signals from NFC components when the antenna 54 is positioned within the magnetic field of the NFC components. Accordingly, the micromodule 42 includes a radio frequency (RF) interface, an NFC device controller, and other NFC-enabled circuitry (not shown) to facilitate enabling NFC communication with (or by) the contactless card 24. The RF interface is configured to receive and transmit RF signals through the antenna 54. The NFC device controller is configured to process the received RF signals and to generate signals to be transmitted by the RF interface. The token data portion 50 of the memory device 44 is configured to store data associated with transmitting and receiving the RF signals. Furthermore, the NFC device controller is coupled in communication with the processor 46.

The processor 46 contains control logic, input/output ports, etc. to enable the micromodule 42 to operate. While not described herein, it is noted that a person skilled in the art of contactless cards will be familiar with the necessary specifications, such as the Mastercard contactless specifications, available under license from Mastercard.

The contactless card 24 includes a laminated body 56, which houses the micromodule 42 and antenna 54. In addition, the contactless card 24 includes a consumer's name 58 and a logo 60 of a financial company whose services are used by the cardholder (e.g., Mastercard). The name 58 and logo 60 are typically printed on the body 56. Moreover, the contactless card 24 includes the PAN 62 and an expiration date 64. The PAN 62 corresponds to the consumer's financial account, which is generally held by the card issuer 18.

FIG. 4A is a simplified block diagram of the memory device 44 representing a memory state before tokenization of the contactless card 24 (shown in FIG. 3). In the exemplary embodiment, before tokenization of the contactless card 24, during a transaction (whether contact (e.g., dipped) or contactless (e.g., tapped or waved)), the contactless card 24 is configured to transmit the payment account information 400 written to the EMV data portion 48 of the memory device 44. As illustrated in FIG. 4A, in the instance in which the contactless card 24 is not tokenized, the token data portion 50 includes a data pointer 402 initially configured to point to the payment account information 400 written to the EMV data portion 48, and more particularly, to a memory address or range containing the payment account information 400. As such, during a non-tokenized contactless transaction with the contactless card 24, the payment account information 400 is transmitted to the POS terminal, such as the POS terminal 32 (shown in FIG. 1).

FIG. 4B is a simplified block diagram of the memory device 44 representing a state after the contactless token 404 has been written to the contactless card 24. In the exemplary embodiment, during a tokenization process (described below), the contactless token 404 is written to the token data portion 50. The pointer 402 is updated to point to the contactless token 404, and more particularly, to a memory address or range containing the contactless token 404. As such, during a contactless transaction with the contactless card 24 (e.g., when the contactless card 24 is “tapped” or “waved” proximate an NFC-enabled POS), the contactless token 404 is transmitted to the NFC-enabled POS, such as the POS terminal 32.

### Exemplary Computer Systems

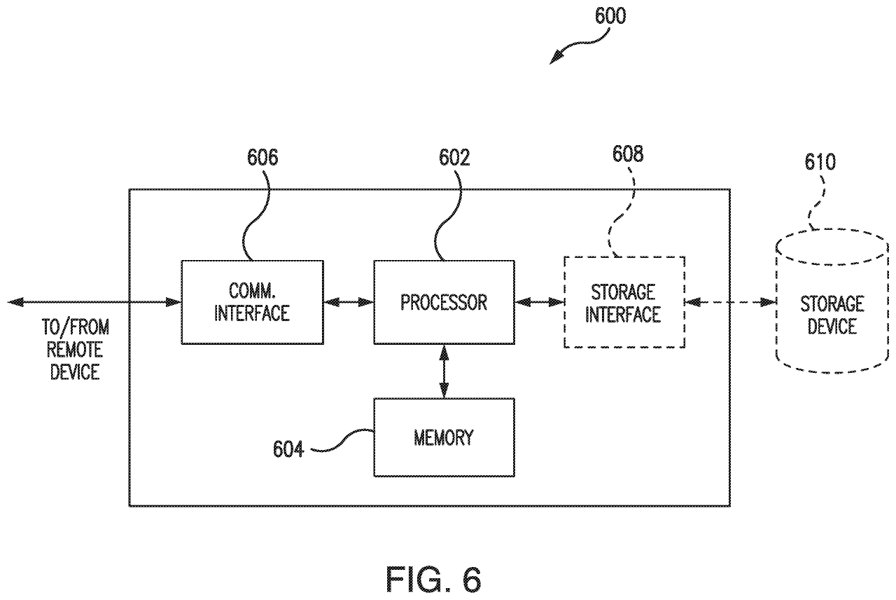

FIG. 5 is an example configuration of a user system 500 operated by a user 501, such as the consumer 22 (shown in FIG. 1). In some embodiments, the user system 500 is a merchant POS terminal 32, a client system 34, a contactless ATM, and/or a consumer computing device 40. In the example embodiment, the user system 500 includes a processor 502 for executing instructions. In some embodiments, executable instructions are stored in a memory device 504. The processor 502 includes one or more processing units, for example, a multi-core processor configuration. The memory device 504 is any device allowing information such as executable instructions and/or written works to be stored and retrieved. The memory device 504 includes one or more computer readable media.

In the example embodiment, the processor 502 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 500 may be widely deployed, it may be impractical to manually update software for each computing system 500. Therefore, the system 10 may, in some embodiments, provide a mechanism for automatically updating the software on the computing system 500. For example, an updating mechanism may be used to automatically update any number of components and their drivers, both network and non-network components, including system level (OS) software components. In some embodiments, the computing system 500 components are dynamically loadable and unloadable; thus, they may be replaced in operation without having to reboot the OS.

The user system 500 also includes at least one media output component 506 for presenting information to the user 501. The media output component 506 is any component capable of conveying information to the user 501. In some embodiments, the media output component 506 includes an output adapter such as a video adapter and/or an audio adapter. An output adapter is operatively coupled to the processor 502 and operatively connectable to an output device such as a display device, for example, and without limitation, a liquid crystal display (LCD), organic light emitting diode (OLED) display, or “electronic ink” display, or an audio output device such as a speaker or headphones.

In some embodiments, the user system 500 includes an input device 508 for receiving input from the user 501. The input device 508 may include, for example, one or more of a touch sensitive panel, a touch pad, a touch screen, a stylus, a position detector, a keyboard, a pointing device, a mouse, and an audio input device. A single component such as a touch screen may function as both an output device of the media output component 506 and the input device 508.

The user system 500 may also include a communication interface/card reader 510, which is communicatively connectable to a remote device such as the server system 30 (shown in FIG. 2) and/or the contactless card 24. The communication interface/card reader 510 may include, for example, a wired or wireless network adapter or a wireless data transceiver for use with Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 504 are, for example, computer readable instructions for providing a user interface to the user 501 via the media output component 506 and, optionally, receiving and processing input from the input device 508. A user interface may include, among other possibilities, a web browser and a client application. Web browsers enable users, such as the user 501, to display and interact with media and other information typically embedded on a web page or a website from the server system 30. A client application allows the user 501 to interact with a server application associated with a merchant.

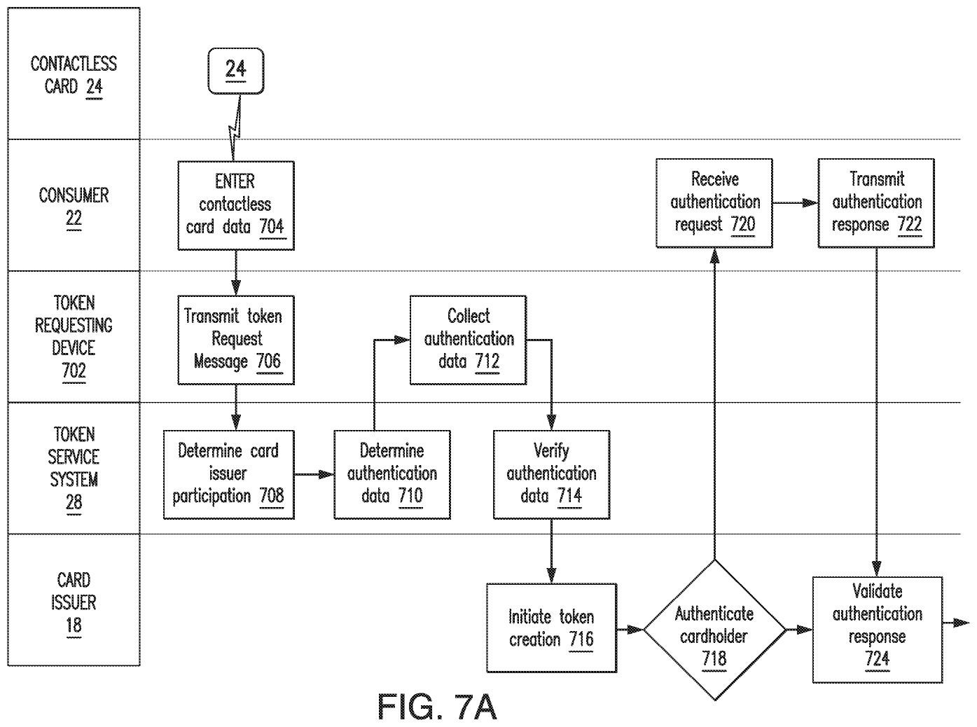

FIG. 6 is an example configuration of a server system 600, such as the server system 30 (shown in FIG. 2). The server system 600 includes, but is not limited to, the transaction database 26 (shown in FIG. 1) and the token service system 28 (shown in FIG. 1). In the example embodiment, the server system 600 includes a processor 602 for executing instructions. The instructions may be stored in a memory area 604, for example. The processor 602 includes one or more processing units (e.g., in a multi-core configuration) for executing the instructions. The instructions may be executed within a variety of different operating systems on the server system 600, such as UNIX, LINUX, Microsoft Windows®, etc. More specifically, the instructions may cause various data manipulations on data stored in a storage device 610 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). In the example embodiment, the processor 602 may be implemented as one or more cryptographic processors, as described above with respect to the user system 600.

The processor 602 is operatively coupled to a communication interface 606 such that the server system 600 can communicate with a remote device such as a user system 500 (shown in FIG. 5) or another server system. For example, the communication interface 606 may receive communications from a POS terminal 32, a client system 34, and/or a consumer computing device 40 via the Internet, as illustrated in FIG. 2.

The processor 602 is operatively coupled to the storage device 610. The storage device 610 is any computer-operated hardware suitable for storing and/or retrieving data. In some embodiments, the storage device 610 is integrated in the server system 600. In other embodiments, the storage device 610 is external to the server system 600 and is similar to the transaction database 26. For example, the server system 600 may include one or more hard disk drives as the storage device 610. In other embodiments, the storage device 610 is external to the server system 600 and may be accessed by a plurality of server systems 600. For example, the storage device 610 may include multiple storage units such as hard disks or solid-state disks in a redundant array of inexpensive disks (RAID) configuration. The storage device 610 may include a storage area network (SAN) and/or a network attached storage (NAS) system.

In some embodiments, the processor 602 is operatively coupled to the storage device 610 via a storage interface 608. The storage interface 608 is any component capable of providing the processor 602 with access to the storage device 610. The storage interface 608 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 602 with access to the storage device 610.

The memory area 604 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Exemplary Computer-Implemented Methods

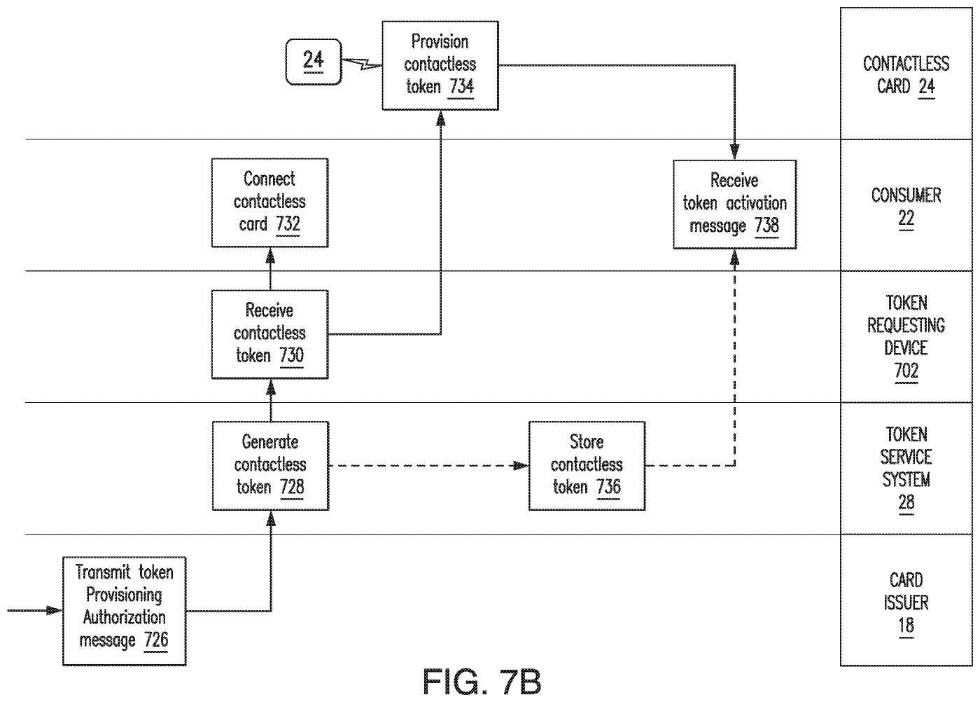

FIGS. 7A and 7B are a flowchart illustrating an exemplary computer-implemented method 700 for tokenizing a contactless payment card, such as the contactless card 24 (shown in FIG. 1), using the system 10 (shown in FIGS. 1 and 2), in accordance with one embodiment of the present disclosure. The operations described herein may be performed in the order shown in FIGS. 7A and 7B or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 700 is described below, for ease of reference, as being executed by exemplary devices and components introduced with the embodiments illustrated in FIGS. 1-6. In one embodiment, the computer-implemented method 700 is implemented by the token service system 28 (shown in FIG. 1). In the exemplary embodiment, the computer-implemented method 700 relates to provisioning a contactless token for a contactless payment card. While operations within the computer-implemented method 700 are described below regarding the token service system 28, according to some aspects of the present invention, the computer-implemented method 700 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, the method 700 includes determining if the consumer 22 (shown in FIG. 1) is an authorized cardholder of the contactless card 24 prior to tokenizing the card. Provisioning a contactless token, such as the contactless token 404 (shown in FIG. 4B), involves the consumer 22, a token requesting device 702 (e.g., the POS terminal 32, the consumer computing device 40, a contactless ATM, and the like), the token service system 28 (shown in FIG. 1), and the card issuer 18 (shown in FIG. 1). In some embodiments, the token requesting device 702 may be operated by the consumer 22, the merchant 12 (shown in FIG. 1), an online merchant, and/or the card issuer 18. In certain embodiments, the token service system 28 is a third-party token provider and not directly associated with the interchange network 16, as is shown in FIG. 1. It should be noted that each party involved in the tokenization method 700 utilizes one or more computing devices such as, for example, and without limitation, the server system 30 (shown in FIG. 2), the processing system 200 (shown in FIG. 2), the POS terminal 32 (shown in FIG. 2), the client system 34 (shown in FIG. 2), the user system 500 (shown in FIG. 5), and/or the server system 600 (shown in FIG. 6), to perform one or more of the operations described herein.

In the exemplary embodiment, the consumer 22 provides his or her contactless card information, such as the PAN and expiry date, as if the consumer 22 was initiating a payment transaction, to the token requesting device 702. In some embodiments, the contactless card information is provided to and stored for use in future transactions, such as in a digital wallet of the consumer computing device 40. In other embodiments, the information is provided simply for use in requesting a contactless token, such as the contactless token 404 (shown in FIG. 4B), and is not stored by the token requesting device 702. The token requesting device 702 requests authentication of the consumer 22. If the consumer 22 is authenticated, the token requesting device 702 receives a contactless token to store instead of contactless card information. The token requesting device 702 may additionally or alternately transmit to the contactless card 24.

In the exemplary embodiment, at operation 704, the consumer 22 requests a token for the contactless card 24 by entering the contactless card data, such as the PAN, expiry date, and CVC value, associated with the contactless card 24 into a registration system of the token requesting device 702. The registration system can include, for example, and without limitation, a digital wallet of the consumer computing device 40 or an information entry system operating on a POS terminal 32. In one embodiment, the consumer 22 can enter the data in any of multiple methods, including, for example, tapping or dipping the contactless card 24 at the token requesting device 702, entering the card data manually (e.g., via a keypad, keyboard, touch screen, etc.), having the token requesting device 702 image the card to extract the data via image recognition, and the like.

At operation 706, the token requesting device 702 transmits a token request message to the token service system 28. At operation 708, the token service system 28 determines whether the card issuer 18 of the contactless card 24 participates in tokenization and, if so, at operation 710 determines what type of authentication data is required by the card issuer 18. At operation 712, the token requesting device 702 collects the required authentication data and passes the authentication data to the token service system 28. The authentication data includes, for example, and without limitation, one or more of the following: (1) token requesting device identifiers (IDs) such as an IP address, a physical address associated with an IP address, a device type, a phone number, geo-location data (e.g., GPS location, country, city, etc.), a device hardware identifier (e.g., a serial number, an IMEI or MEID number, etc.), and the like; and (2) data provided by the consumer 22 such as, a PIN associated with the contactless card 24, a biometric identifier of the consumer (e.g., a finger print, retina scan, etc.), consumer contact information (e.g., an email address, a mobile phone number, a landline phone number, a confirmed shipping address, etc.), and the like.

At operation 714, the token service system 28 verifies that the collected authentication data is complete and transmits the authentication data to the card issuer 18, which, in the example embodiment, allows or denies the token creation process to proceed. If the token creation process is allowed to proceed, at operation 716, the card issuer 18 initiates token creation. At operation 718, the card issuer 18 determines whether to initiate an additional authentication and response query with the consumer 22, such as a one-time password (OTP) and response, a separate authentication email and response, etc. In the example embodiment, the card issuer 18 initiates this process when the card issuer 18 determines that a risk is “high” (e.g., if the authentication data is partially incorrect or unrecognized), and omits this process when the card issuer 18 determines that the risk is “low” and proceeds directly to operation 726.

If the card issuer 18 determines that an additional authentication and response query with the consumer 22 is required, at operation 720, the consumer 22 receives an authentication request from the card issuer 18. This authentication request uses a method of communication that was established between the consumer 22 and the card issuer 18 when the consumer 22 was issued the contactless card 24. In one suitable embodiment, the authentication request may be an email message or an SMS message transmitted to the consumer 22 with a password or a webpage link to visit to continue with the tokenization of the contactless card 24. In other embodiments, the authentication request may include a request for a biometric identifier, an answer to one or more previously established security questions, a temporary password, a one-time password, or other data to authenticate the consumer 22. At operation 722, the consumer 22 enters the authentication response and transmits it to the card issuer 18. The card issuer 18 validates the authentication response at operation 724.

After the card issuer 18 validates the authentication response or if the card issuer 18 previously determined that the additional authentication and response query was not required, at operation 726, the card issuer 18 transmits a token provisioning authorization message to the token service system 28. At operation 728, the token service system 28 creates a token, such as the contactless token 404, and transmits the token 404 to the token requesting device 702. At operation 730, the token request device 702 receives the contactless token 404 and, at operation 732, presents a message to the consumer 22 requesting that the consumer 22 tap or dip the contactless card 24 at the token requesting device 702. At operation 734, the token requesting device 702 provisions the contactless token 404 to the contactless card 24 by writing the contactless token 404 to the token data portion 50 of the micromodule 42. In the example embodiment, provisioning of the contactless token 404 to the contactless card 24 includes, without limitation, updating the pointer 402 to point to the contactless token 404, and more particularly, to a memory address or range containing the payment account information 400. Furthermore, in certain embodiments, such as those where the token requesting device 702 is the consumer computing device 40, at optional operation 736, the token requesting device 702 stores the contactless token 404, such as in a digital wallet, for future payment transactions.

At operation 738, the consumer 22 then receives a token activation message indicating that the contactless token 404 is provisioned for use. The token service system 28 stores the contactless token 404 and the PAN associated with the contactless token 404 in a database, such as the database 26 (i.e., a “Token Vault”), for use in subsequent payment transaction authorizations. Thus, in future transactions between the consumer 22 and a merchant, such as the merchant 12, the contactless card 24 transmits the contactless token to the POS terminal 32 during a contactless transaction. The merchant 12 transmits an authorization request message to the acquirer 14, which passes the authorization request to the interchange network 16. The authorization request message includes the contactless token 404 in the place of the PAN. The acquirer 14 or interchange network 16 uses the contactless token 404 to query the “Token Vault” of the token service system 28 to retrieve the PAN associated with the contactless token 404. In the example embodiment, interchange network 16 transmits the PAN to the card issuer 18 with the authorization request and the card issuer 18 determines whether to authorize the transaction.

As described herein, transaction data can be compromised, such as in merchant data breaches, compromised transactions (e.g., via eavesdropping), and the like. Thus, it is possible that the PAN and/or the contactless token 404 can be exposed, intercepted, and/or stolen by fraudsters. Furthermore, PANs have expiry dates as do at least some tokens. In such instances, the contactless token 404 is deactivated and requires updating.

In one embodiment, the token service system 28 informs the consumer 22 that the contactless token 404 will need to be updated with a new contactless token. For example, the token service system 28 may push a notification to the consumer computing device 40, or, in some embodiments, push a notification to the POS terminal 32, contactless ATM, or the like, when the consumer 22 attempts a transaction with an outdated or compromised contactless card 24. To continue using the contactless card 24, the consumer 22 needs to update the contactless token 404 by initiating the tokenization method described above with respect to FIGS. 7A and 7B.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A computer-implemented method for tokenizing a contactless payment card, said contactless payment card comprising a micromodule including a processor and a memory device, said memory device including an EMV data portion and a token data portion, said EMV data portion having stored thereon contactless card data, said token data portion having stored thereon a pointer initially pointing to the contactless card data, said method comprising:
receiving, by a token requesting device, the contactless card data from the contactless payment card;
transmitting, by the token requesting device, a token request message to a token service system, the token request message including the contactless card data;
generating, by the token service system, a contactless token for the contactless payment card, the contactless token being associated with the contactless card data;
establishing, by the token requesting device, a wireless communication connection with the contactless payment card;
writing, by the token requesting device, the contactless token to the token data portion of the contactless payment card memory device; and
updating, by the token requesting device, the pointer stored in the token data portion of the contactless payment card memory device to point to the contactless token.

2. The method in accordance with claim 1,
said operation of receiving the contactless card data comprising:
establishing, by the token requesting device, a wireless communication connection with the contactless payment card; and
reading, by the token requesting device, the contactless card data directly from the contactless payment card memory device.

3. The method in accordance with claim 1, further comprising:
determining, by the token service system, whether a card issuer of the contactless payment card allows for tokenizing the contactless payment card;
determining a plurality of authentication data required by the card issuer; and
receiving, from the token requesting device, the plurality of authentication data.

4. The method in accordance with claim 3, further comprising:
verifying that the plurality of authentication data is complete; and
transmitting, by the token service system, the plurality of authentication data to the card issuer.

5. The method in accordance with claim 3,
the plurality of authentication data comprising one or more of the following token requesting device identifiers: an IP address, a physical address associated with an IP address, a device type, a phone number, geo-location data, and a device hardware identifier.

6. The method in accordance with claim 3, further comprising determining, by the card issuer, whether to initiate an authentication and response query with an authorized cardholder of the contactless payment card.

7. The method in accordance with claim 6, further comprising:
transmitting, to the authorized cardholder, an authentication request;
receiving, from the authorized cardholder, an authentication response; and
validating the authentication response.

8. The method in accordance with claim 7, wherein the authentication request comprises one or more of the following: an email message, an SMS message, a request for a biometric identifier, an answer to one or more previously established security questions, a temporary password, and a one-time password.

9. The method in accordance with claim 1, further comprising transmitting, by a card issuer of the contactless payment card, a token provisioning authorization message to the token service system.

10. The method in accordance with claim 1, further comprising storing, in a memory of the token requesting device, the contactless token.

11. A system comprising:
a contactless payment card comprising a micromodule including a processor and a card memory device, said card memory device including an EMV data portion and a token data portion, said EMV data portion having stored thereon payment account information associated with an authorized cardholder of said contactless payment card, said token data portion having stored thereon a pointer initially pointing to the payment account information;
a token service system comprising a first processor programmed to receive the payment account information and generate a contactless token for said contactless payment card, the contactless token being associated with the payment account information; and
a token requesting device comprising a second processor communicatively coupled to a token requesting device memory device, said second processor programmed to:
receive the payment account information from the card memory device;
transmit a token request message to said token service system, the token request message including the payment account information;
establish a wireless communication connection with the contactless payment card;
write the contactless token to the token data portion of the card memory device; and
update the pointer stored in the token data portion of the card memory device to point to the contactless token.

12. The system in accordance with claim 11,
said second processor being further programmed, as part of receiving the payment account information, to:
establish a wireless communication connection with the contactless payment card; and
read the payment account information directly from the card memory device.

13. The system in accordance with claim 11,
said first processor further programmed to:
determine whether a card issuer of said contactless payment card allows for tokenizing the contactless payment card;
determine a plurality of authentication data required by the card issuer; and
receive, from said token requesting device, said plurality of authentication data.

14. The system in accordance with claim 13,
said first processor further programmed to:
verify that said plurality of authentication data is complete; and
transmit said plurality of authentication data to the card issuer.

15. The system in accordance with claim 13,
said plurality of authentication data comprising one or more of the following token requesting device identifiers: an IP address, a physical address associated with an IP address, a device type, a phone number, geo-location data, and a device hardware identifier.

16. The system in accordance with claim 13, further including a card issuer computing device programmed to determine whether to initiate an authentication and response query with the authorized cardholder.

17. The system in accordance with claim 16, the card issuer computing device further programmed to:
transmit, to the authorized cardholder, an authentication request;
receive, from the authorized cardholder, an authentication response; and
validate the authentication response.

18. The system in accordance with claim 17, wherein the authentication request comprises one or more of the following: an email message, an SMS message, a request for a biometric identifier, an answer to one or more previously established security questions, a temporary password, and a one-time password.

19. The system in accordance with claim 11, further comprising a card issuer computing device programmed to transmit a token provisioning authorization message to said system.

20. The system in accordance with claim 11, said second processor further programmed to store, in said token requesting device memory device, the contactless token.
